(19) United States
(12) Patent Application Publication
(10) Pub. No.: US 2022/0175491 A1
(43) Pub. Date: Jun. 9, 2022

(54) METHOD FOR ESTIMATING AND VIEWING A RESULT OF A DENTAL TREATMENT PLAN

(71) Applicant: DEEPSMILE TECHNOLOGY, Aix En Provence (FR)

(72) Inventors: Achraf BEN-HAMADOU, Aix En Provence (FR); Ahmed REKIK, Aix En Provence (FR); Hugo SETBON, Aix En Provence (FR)

(21) Appl. No.: 17/310,578

(22) PCT Filed: Feb. 24, 2020
(86) PCT No.: PCT/FR2020/050348

§ 371 Date: Aug. 12, 2021

(30) Foreign Application Priority Data
Feb. 22, 2019 (FR) 1901837
Mar. 22, 2019 (FR) 1903007

(51) Int. Cl. A61C 7/00; A61C 9/00; A61C 13/34; G06T 19/20

(52) U.S. Cl. CPC A61C 7/002; A61C 9/0053; G06T 2210/41; G06T 19/20; G06T 2219/2004; A61C 13/34

(57) ABSTRACT

The method (100) for estimating and viewing a result of a dental treatment plan comprises:
a step (105) of reconstructing, in a virtual space in three-dimensions, the shape of the face of a patient,
a step (125) of reconstructing, in the virtual space in three-dimensions, the dentition of a patient,
a step (142) of assembling the reconstructed shape of the face and the reconstructed dentition in the virtual space in three-dimensions,
a step (145) of determining at least one dental treatment plan depending on the modeled dentition and face,
a step (150) of selecting a treatment plan from the set of determined treatment plans,
a step (155) of computing an image of how the face of the patient will look after the dental treatment depending on an image of the face of the patient and on the selected treatment plan and
a step (160) of displaying the computed image.

### TECHNICAL FIELD OF THE INVENTION

The present invention relates to a method for estimating and viewing a result of a dental treatment plan. It applies, among others, to the field of orthodontics and dental prosthetics and relates, in particular, to estimating the result and viewing a treatment plan.

### STATE OF THE ART

Currently, when a dental treatment must be carried out on a patient, the current solutions do not make it possible to determine the impact on the patient's face in advance. Therefore, no aesthetic criterion is currently taken into consideration in establishing a dental treatment plan.

To formulate a treatment plan, a practitioner uses an intra-oral scanning device to determine the position of the teeth and the overall structure of the dentition. The result of this capture is then sent to an analysis center which in return provides a treatment plan and a view of the dentition after the treatment. This cycle can take several weeks and requires a large number of qualified people to produce this view. In addition, the treatment plans suggested are rarely followed, because they are clinically faulty. One of the reasons for this defect is that the impact of the treatment plan on the soft tissues is not taken into consideration. This absence of consideration results in the impact of the treatment plan on a patient's face not being known.

Thus, there is currently no solution making it possible to automatically formulate a dental treatment plan based on a result to be achieved that takes into consideration a preference and the aesthetic impact on the patient's face.

Among others, systems as described in patent application US 2018/174367 are known. Such a system aims to provide a virtual dentition model that can be displayed, especially in augmented reality by superimposition onto a video flow of the jaw of a user.

Such systems only use the teeth to determine the final result of a treatment, which makes the result prediction very uncertain and not very reliable.

Such systems use the face to determine a 2D plane of symmetry making it possible to position the modeled dentition model, without adapting the model to the specific shape of the user's face.

Such systems are limited to the superimposition of a virtual dentition model onto an actual image flow captured, which leads to a rendering that is unreliable and inclined to display errors due to the simultaneous display of the actual flow and the virtual flow of dentition.

Systems as described in patent application US 2018/263733 are also known. Such systems aim to display, on a user's face, a modified dentition based on a treatment carried out.

Such systems use a 2D image of the face to determine the impact of a treatment plan, which makes the result prediction very uncertain and not very reliable because many anatomical landmark positions, such as the tip of the nose for example, are poorly defined.

Such systems use the face solely to position a virtual rendering of the teeth.

Such systems use a rigid alignment (rotation, translation).

Such systems analyze the face solely in two dimensions.

### DESCRIPTION OF THE INVENTION

The present invention aims to remedy all or part of these drawbacks.

To this end, the present invention relates to a method for estimating and viewing a result of a dental treatment, which comprises:
a step of positioning retractors in a patient's mouth;
a step of reconstructing the shape of the patient's face in a first 3D virtual space, comprising:
   a first step of capturing, by an RGB-D capture device, at least one image of the patients face; and
   a first step of fitting the shape of at least one portion of the patients face onto a parametric face shape model based on at least one captured image of the face;
a step of reconstructing the dentition of a patient in a second 3D virtual space, comprising:
   a step of capturing, by a capture device, an image of the dentition of the patient;
   a step of computing a probabilistic contour map of at least one tooth of the dentition based on at least one captured image; and
   a step of modeling the 3D shape of at least one tooth based on a probable position of at least one contour;
a step of assembling the reconstructed face shape and the reconstructed dentition in a common 3D virtual space;
a step of removing retractors from the patient's mouth;
a second step of capturing an image of the patients face shape;
a second step of fitting the patients face shape onto a parametric face shape model based on at least one image of the face captured during the second capture step, in a 3D space;
a step of positioning the modeled dentition in the 3D virtual space of the face shape fitted during the second fitting step;
a step of determining at least one dental treatment plan based on both the modeled dentition and face shape;
a step of selecting a treatment plan from the set of determined treatment plans;
a step of computing an image of how the patients face will look after the dental treatment based on an image of the patients face captured during the second capture step and on the selected treatment plan; and
a step of displaying the computed image.

Thanks to these provisions, the patient can view the impact of a treatment plan on the shape of his face and therefore choose, based on aesthetic criteria, whether or not he wants to carry out this treatment plan. In addition, the practitioner can thus obtain, immediately, the treatment plan to be carried out to achieve the result displayed. In addition, these provisions make it possible to see in real time the impact of a change of treatment plan.

This method also presents a clear advantage of reliability of the prediction produced because of using the face as a modeling parameter and not only to serve as a reference point for displaying a dentition modeled independently.

In some embodiments, the method that is the subject of the present invention comprises a step of automatically learning how to recognize an anatomical landmark based on at least one captured image, the detection step being based on the machine learning performed.

These embodiments make it possible to significantly improve the detection of an anatomical landmark by learning how to identify these landmarks, using images captured beforehand.

In some embodiments, the method that is the subject of the present invention comprises a step of automatically learning how to recognize a tooth based on at least one captured image, the detection step being based on the machine learning performed.

These embodiments make it possible to significantly improve the detection of the shape of a tooth by learning how to identify these tooth shapes from a set of captured points, using images captured beforehand.

In some embodiments, the step of automatically learning how to recognize a tooth is configured to learn a statistical distribution of tooth shapes from captured 3D tooth scans to produce a parametric tooth shape model.

In some embodiments, the display step is performed in augmented reality, the method comprising, before the display step, a step of reducing a portion of the face of a user captured in a flow of images.

These embodiments improve the ergonomics and the ease of viewing the impact of a treatment plan on the patients face.

In some embodiments, the method that is the subject of the present invention comprises a step of positioning a retractor in the patient's mouth before the step of reconstructing the dentition of said patient.

These embodiments make it possible to obtain a better image capture of the dentition, thereby improving the ability to detect the shape of the teeth of a dentition.

In some embodiments, the method that is the subject of the present invention comprises a step of positioning mirrors in the patient's mouth before the step of reconstructing the dentition of said patient.

These embodiments make it possible to obtain a better image capture of the dentition, especially molars, thereby improving the ability to detect the shape of the molars of a dentition.

In some embodiments, during the step of capturing at least one image of an object representative of the dentition of the patient, at least one captured image is in two dimensions.

These embodiments make it possible to utilize a low-cost image capture device.

In some embodiments, during the step of capturing at least one image of the patient's face shape, at least one captured image is in two dimensions.

These embodiments make it possible to utilize a low-cost image capture device.

In some embodiments, the image captured during the step of capturing at least one image of at least one tooth of the patient is an image of an impression of the patients teeth.

These embodiments make it possible to utilize a low-cost image capture device.

In some embodiments, the method that is the subject of the present invention comprises a step of providing, based on the treatment plan chosen, a schedule of tasks to be carried out.

These embodiments make it possible for the practitioner to propose a schedule corresponding to the selected action plan to the patient.

In some embodiments, the second detection step is performed based on the parametric fitting of the shape of a captured tooth relative to a distribution of tooth shapes obtained beforehand.

In some embodiments, the second capture step captures at least one 2D image of a tooth from one camera angle, the second detection step performing the parametric fitting of the shape of a tooth based on a projection corresponding to the camera angle.

In some embodiments, the method that is the subject of the present invention comprises a step of automatically learning a statistical distribution of tooth shapes from captured 3D tooth scans to produce a parametric tooth shape model.

In some embodiments, the detection step produces a probabilistic map of a contour forming part of an anatomical set.

### BRIEF DESCRIPTION OF THE FIGURES

Other advantages, aims and particular features of the invention will become apparent from the non-limiting description that follows of at least one particular embodiment of the method that is the subject of the present invention, with reference to drawings included in an appendix, wherein:

FIG. 1 represents, schematically and in the form of a logic diagram, a particular series of steps of a first embodiment of the method that is the subject of the present invention;

FIG. 2 represents, schematically and in the form of a logic diagram, a particular series of steps of a first embodiment of the method that is the subject of the present invention;

FIG. 3 represents, schematically, a first step of capturing an image of the face of a patient of the method that is the subject of the present invention;

FIG. 4 represents, schematically, a step of capturing an image of at least one tooth of a patient of the method that is the subject of the present invention;

FIG. 5 represents, schematically, a step of assembling a modeled shape of the face and a modeled dentition of the method that is the subject of the present invention;

FIG. 6 represents, schematically, a second step of capturing an image of the face of a patient of the method that is the subject of the present invention; and

FIG. 7 represents, schematically, a step of positioning a modeled dentition in a landmark corresponding to a captured face shape.

### DESCRIPTION OF EMBODIMENTS

The present description is given in a non-limiting way, in which each characteristic of an embodiment can be combined with any other characteristic of any other embodiment in an advantageous way.

Note that the figures are not to scale.

Note that the term “capture device” can denote one capture device or a plurality of synchronous or asynchronous capture devices.

Note that the term “image” can refer to a 2D image, a 3D image, a 3D scanned image, or a video, more broadly.

Note that the terms “reconstructing” and “modeling” are equivalent insofar as they designate the transposition of a physical object into a 3D virtual space.

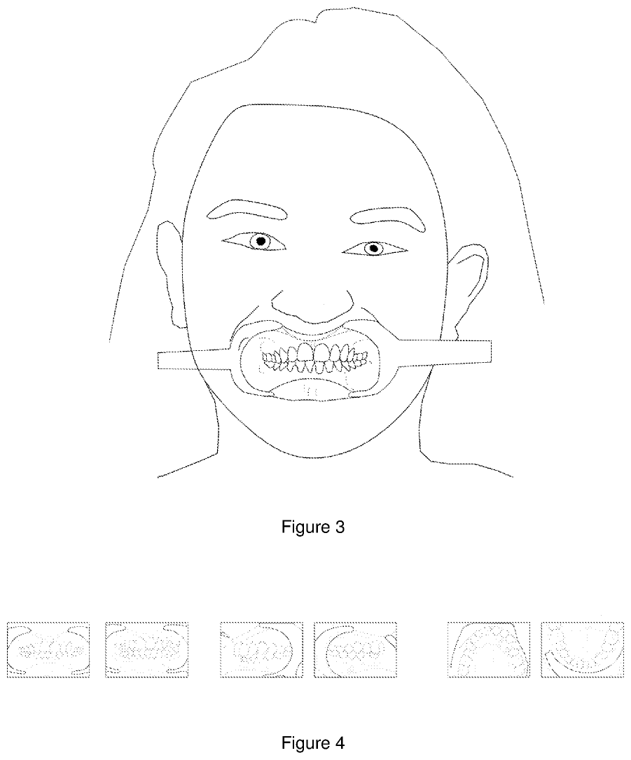

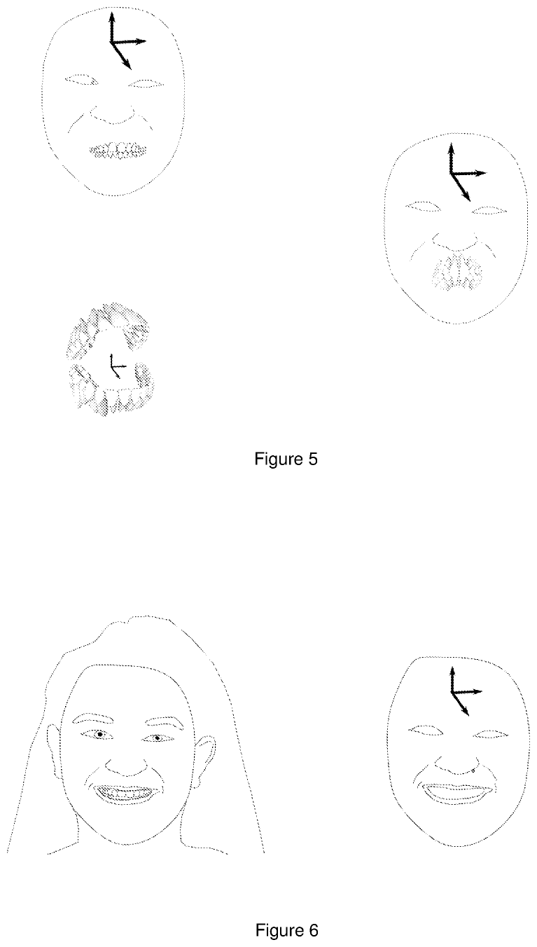

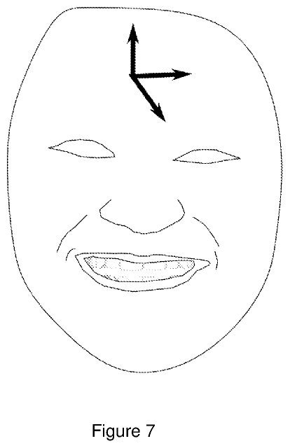

In a preferred embodiment, it is understood conceptually that the method which is the subject of the present invention comprises the following steps:
capturing an image of the patient's face, with retractors in the mouth and with the teeth closed, as shown in FIG. 3;
capturing a plurality of images of the dentition of the patient, with retractors in the mouth and with the teeth closed and then open, as shown in FIG. 4;
parametric modeling of the face shape, including modeling surfaces of the upper portion of the face, such as the forehead or nose, in a first landmark, as shown in FIG. 5;
parametric modeling of the shape of the teeth and modeling of the dentition, in a second landmark, as shown in FIG. 5;
assembling the modeled teeth and face shapes, as shown in FIG. 5;
capturing an image of the face of the patient without retractors, and preferably smiling, as shown in FIG. 6;
fitting a model of the face captured without retractors with the model obtained from the image captured with retractors, as shown in FIG. 6; and
assembling a dentition in the landmark of the face with no retractor;
determining a treatment plan;
computing a post-treatment plan image in the modeled image of the patient's face, as shown in FIG. 7; and
displaying the result in an image of the patients face.

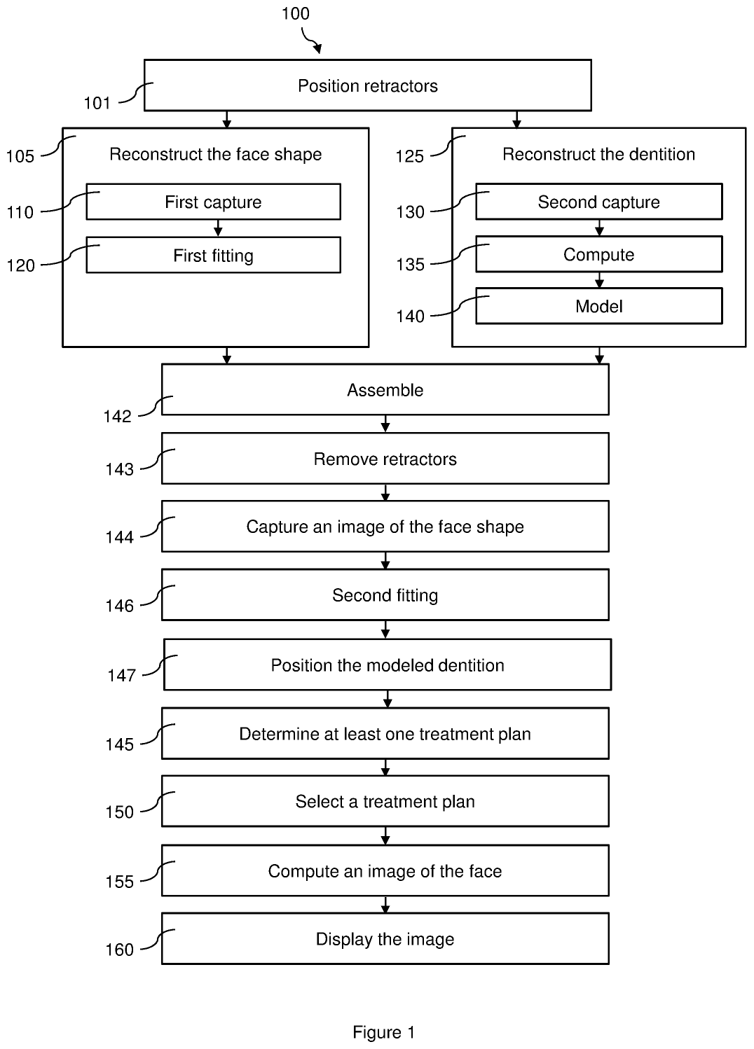

FIG. 1, which is not to scale, shows a schematic view of an embodiment of the method 100 that is the subject of the present invention. This method 100 of estimating and viewing a result of a dental treatment plan comprises:
a step 101 of positioning retractors in a patient's mouth;
a step 105 of reconstructing a patients face shape in a first 3D virtual space; comprising:
   a first step 110 of capturing, by an RGB-D capture device, at least one image of the patient's face; and
   a first step 120 of fitting the patients face shape onto a parametric model of at least one portion of the face based on at least one captured image of the face;
a step 125 of reconstructing the dentition of a patient in a second 3D virtual space, comprising:
   a step 130 of capturing, by a capture device, an image of the dentition of the patient;
   a step 135 of computing a probabilistic contour map of at least one tooth of the dentition based on at least one captured image; and
   a step 140 of modeling the 3D shape of at least one tooth based on a probable position of at least one contour;
a step 142 of assembling the reconstructed face shape and the reconstructed dentition in a common 3D virtual space;
a step 143 of removing retractors from the patient's mouth;
a second step 144 of capturing an image of the patients face shape;
a second step 146 of fitting the patient's face shape onto a parametric face shape model based on at least one image of the face captured during the second capture step, in a 3D space;
a step 147 of positioning the modeled dentition in the 3D virtual space of the face shape fitted during the second fitting step;
a step 145 of determining at least one dental treatment plan based on both the modeled dentition and face shape;
a step 150 of selecting a treatment plan from the set of determined treatment plans;
a step 155 of computing an image of how the patients face will look after the dental treatment based on an image of the patients face and on the selected treatment plan; and
a step 160 of displaying the computed image.

The step 101 of positioning retractors can be performed by an operator so as to make at least one portion of the dentition of the patient visible.

The step 143 of removing retractors can be performed by an operator.

In some variants, the first capture step 110 is performed, for example, by utilizing an image capture device. This image capture device is, for example, a camera or a video capture camera. Any image capture device known to the person skilled in the art can be used here. For example, use of a smartphone equipped with a camera enables this capture step 110 to be performed. In some variants, an RGB-D (for “Red Green Blue—Depth”) capture device, able to capture both the color and depth value of each pixel of a photographed object, is used.

Preferably, the capture device is positioned facing the patient whose face shape must be reconstituted in three dimensions.

In some variants, a plurality of images is captured. In some variants, at least two captured images are captured from a different angle relative to the patient's face. In some variants, at least one portion of a plurality of images is captured along a circular arc surrounding the patients face.

In some variants, the capture device only captures photographs. In some variants, the capture device only captures videos. In some variants, the capture device captures a combination of photographs and videos.

Increasing the number of angles of view make it possible to increase the reliability of the 3D face shape modeling. In some preferred variants, three images are captured in this way.

In some embodiments, during the step 110 of capturing at least one image of the patients face shape, at least one captured image is in two dimensions. These embodiments make the step 120 of fitting the face shape in three dimensions more complex, but make it possible to use capture devices that are less expensive and more widely available.

The first detection step 115 is performed, for example, by utilizing an electronic computing circuit, such as a computer or server, configured to detect at least one anatomical landmark from at least one captured image.

The term “anatomical landmark” refers, for example, to the glabella, philtrum, tip of the nose, corners of the eyes, lips and chin.

Some of these anatomical landmarks, for example the chin, the corner of the eyes and the lips, are well defined in 2D images and can therefore be recognized by means of shape recognition algorithms in 2D images. However, in contrast certain anatomical landmarks are characterized by 3D geometric shapes, such as the chin or the tip of the nose. Therefore, using a 3D image capture device is naturally indicated from a technical point of view to make it easier to recognize said landmarks.

Nevertheless, in some preferred variants, the choice of a 2D image capture device is preferred despite this technical contra-indication, for reasons of cost and accessibility of the capture device in particular.

In some current systems, the protocol utilized by a dental practitioner consists of manually collecting photographs of anatomical landmarks to deduce 3D measurements by using, for example, a caliper or an equivalent process. This process takes time and does not take the actual geometry/shape of the face into account.

An image processing algorithm can be used to automatically identify an anatomical landmark from at least one 2D image, this algorithm being configured to recognize a predefined pattern and associate a type of anatomical landmark with this pattern.

In some variants, at least one image used in this way presents depth information associated with each pixel captured. Each such image is captured, for example, by an RGB-D capture device.

In some variants, at least two 2D images are captured and an interpolation is carried out to associate a pixel representative of a single portion of the face with coordinates in a virtual geometric reference space, by triangulation for example.

In other variants, the 3D reconstruction of the shape of the patient's face is performed according to the method described in the document “Monocular 3D facial shape reconstruction from a single 2D image with coupled-dictionary learning and sparse coding” by authors Pengfei Dou, Yuhang Wu, Shishir K. Shah and loannis A. Kakadiaris, published in the journal “Pattern Recognition”, Volume 81, September 2018, pages 515-527.

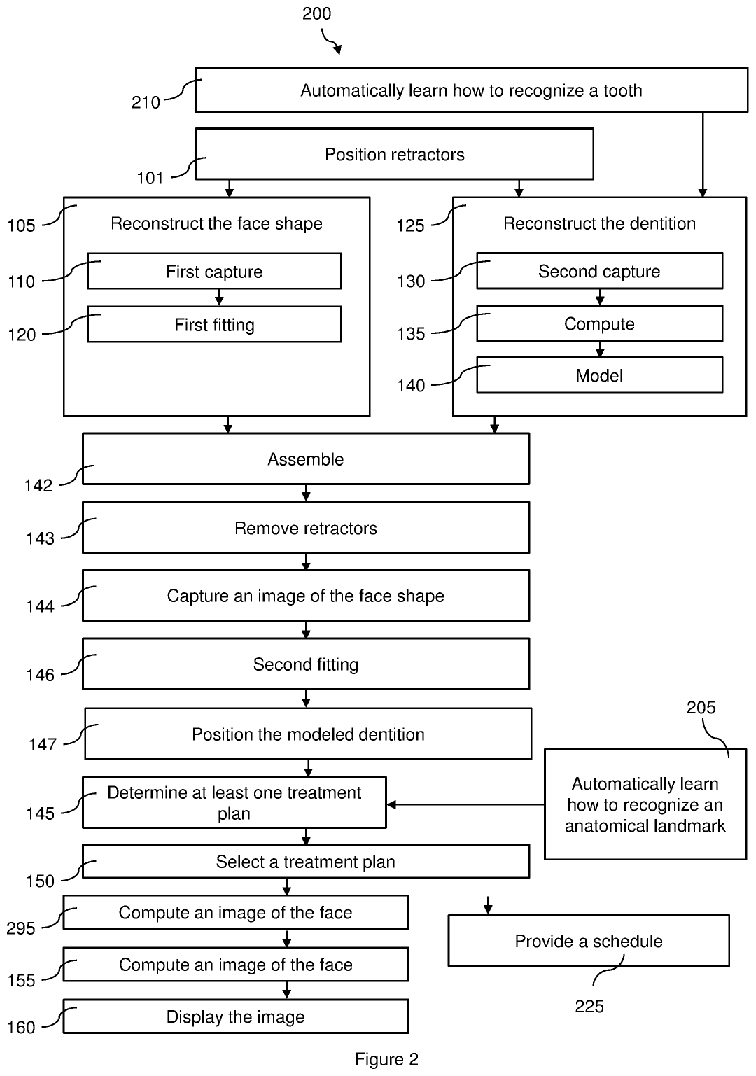

In some embodiments, such as that shown in FIG. 2, the method 200 comprises a step 205 of automatically learning how to recognize an anatomical landmark based on at least one captured image, the detection step 115 being based on the machine learning performed.

The learning step 205 is carried out, for example, by utilizing a machine learning algorithm based on a sample of captured images representative of determined anatomical landmarks.

The fitting step 120 is performed, for example, by utilizing an electronic computing circuit, such as a computer or server, configured to compute a face shape in a virtual geometric reference space from detected anatomical landmarks.

For example, during this fitting step 120, at least one anatomical landmark is positioned according to the geometric reference space, the face shape being extrapolated, or interpolated, from the coordinates of each said landmark. By way of example, if the coordinates of the base of the nostrils and the coordinates of the perimeter of the lips are known, the shape of the philtrum or the nasal groove can be determined using a mathematical model so as to link the coordinates of the base of the nostrils and the coordinates of the perimeter of the lips.

In some variants, this fitting step 120 is performed according to the method described in the document “A Multiresolution 3D Morphable Face Model and Fitting Framework”, published in 2015, by authors Patrik Huber, Guosheng Hu, Rafael Tena, Pouria Mortazavian, Willem P. Koppen, William Christmas, Matthias Rätsch & Josef Kittler.

In some particular embodiments, such as that shown in FIG. 2, the method 200 comprises a step 101 of positioning a retractor in the patient's mouth before the step 125 of reconstructing the dentition of said patient.

In some particular embodiments, such as that shown in FIG. 2, the method 200 comprises a step of positioning mirrors in the patients mouth before the step 125 of reconstructing the dentition of said patient.

The reconstruction step 125 can be carried out, for example, by a practitioner utilizing an intra-oral scanning device providing, when used, a 3D model of the dentition of a patient. This intra-oral scanning device then successively carries out:
the second step 130 of capturing at least one image of an object representative of the dentition of the patient and, optionally, at least one depth value between a point of the object and the capture device;
the second step 135 of statistically computing the contours of at least one tooth of the dentition based on at least one captured image; and
the second step 140 of modeling the 3D shape of at least one tooth based on the detected position of at least one set of points.

The term “intra-oral scanning device” means both the scanning device and the electronic computing device connected to it that provides a model of the shape of at least one portion of the dentition of the patient. The operation mode of an intra-oral scanning device is well known to the person skilled in the art of medical devices for dental applications and this operation is not repeated here.

Therefore, using a 3D image capture device is naturally indicated from a technical point of view to make it easier to reconstruct the shape of at least one portion of the dentition of a patient in a virtual geometric reference space.

Nevertheless, in some preferred variants, the choice of a 2D image capture device is preferred despite this technical contra-indication, for reasons of cost and accessibility of the capture device in particular.

In these variants, the second capture step 130 is performed, for example, by utilizing an image capture device. This image capture device is, for example, a camera or a video capture camera. Any image capture device known to the person skilled in the art can be used here. For example, this capture step 130 can be performed by using a smartphone equipped with a camera. In some variants, an RGB-D capture device, able to capture both the color and depth of each pixel of a photographed object, is used.

Preferably, the capture device is positioned facing the patient whose dentition must be reconstituted in three dimensions.

In some variants, a plurality of images is captured. In some variants, at least two captured images are captured from a different angle relative to the patient's face. In some variants, at least one portion of a plurality of images is captured along a circular arc surrounding the dentition of the patient.

In some variants, the capture device only captures photographs. In some variants, the capture device only captures videos. In some variants, the capture device captures a combination of photographs and videos.

Increasing the number of angles of view make it possible to increase the reliability of the 3D dentition modeling.

In some particular embodiments, such as that shown in FIG. 2, the image captured during the step 130 of capturing at least one image of at least one tooth of the patient is an image of an impression of the patient's teeth.

Such an impression is, for example, produced in silicone by the practitioner.

The second computation step 135 is performed, for example, by utilizing an electronic computing circuit, such as a computer or server, configured to detect at least one tooth of a dentition from at least one captured image.

This second computation step 135 can be based on a statistical model of 3D tooth shapes. Such a model is constructed, for example, from a large number of 3D tooth scans. The advantage of such an approach is that it makes it possible to statistically model the deformations of the shapes of teeth and to parametrize them. This means that it is possible to reproduce the shapes of any tooth whatsoever simply by adjusting the parameters of the 3D statistical shape model.

The same constructed 3D statistical shape model of teeth can be used to reconstruct tooth shapes from captured 3D tooth scans or from photographs of teeth.

In the first case, the 3D tooth scans are complete, and the adjustment of the statistical model incorporates fewer parameters, in particular the projection of the 2D model corresponding to the silhouettes of teeth, for example. In contrast, in the case where photographs of teeth are used, the adjustment of the statistical shape model from photographs requires also taking into account the camera's angle of view and the visibility of teeth in the photographs. The adjustment of parameters is based in this case on comparing the projection of the model adjusted in relation to the appearance of the teeth in the photographs (especially the silhouette of the teeth).

The production of a 3D shape model of teeth consists of statistically modeling the distribution of the 3D shapes of different teeth.

The production of this model can be based on the following steps:
manual segmentation of the teeth by means of the 3D scan of teeth: each tooth is cropped from the other teeth and the gums; and
annotation of types of cropped teeth.

In this way, a database is constructed into which, for each type of tooth, all the 3D shapes extracted for all the patients whose dentition has been captured are placed.

In addition, the production of this model can be based on a step of statistically learning the shape model of separate teeth: once the database has a large enough number of annotated 3D teeth, the statistical shapes can be leaned for each type of tooth. To this end, all segmented teeth in three dimensions of the same type are placed in the same reference space. In other words, these segmented teeth are superimposed in a reference frame, which is a type of generic 3D tooth model produced by a graphic artist in a manner appropriate for each type of tooth. This superimposition involves a rigid positioning (translation and rotation in three dimensions). Variations in 3D shapes are taken into account in the following step, which consists of deforming the generic tooth models to fit as closely as possible the 3D tooth shapes. This consists of a deformable adjustment which moves the surface of the generic models to bring them as close as possible to the actual surfaces of the segmented teeth under a certain geometric constraint. As a result of this chaining of rigid and then deformable adjustment of the generic models of teeth, the minimum set of deformation vectors covering all the tooth shapes present in the learning database is identified. This estimation is carried out by principal component analysis of all the deformations previously carried out at the time of the deformable adjustment. As a result of this analysis, 3D deformation vectors are obtained for a subset of points in three dimensions that make up the generic models with, in addition, a distribution of the amplitude of deformation associated to each of the vectors. This makes it possible to reproduce all the tooth shapes by adjusting the amplitude of the deformation vectors which are applied to the generic models of teeth.

In addition, the production of this model is based on a step of reconstruction in three dimensions from a set of images. This step consists of the processing that makes it possible to infer the 3D shapes of the teeth from a set of acquired images for a patient's teeth from different angles and under different conditions. On input to this step, we have the 3D statistical shape model of teeth which must be fitted to match the teeth visible in the photographs. The teeth have a distinctive appearance in the photographs (lack of texture and a high level of reflectance). The most relevant information to be considered for characterizing the appearance of the teeth is the contour information for the teeth. Consequently, the step consists, for example, of two sub-steps:
firstly, the probabilistic detection of the contours of the teeth; and
subsequently, fitting the 3D statistical shape model to the teeth contours detected.

The sub-step of the probabilistic detection of the contours of teeth does not consist of the detection of a contour in a binary way, but rather of associating to each contour point a score or a probability that indicates the likelihood that a point in question forms part of a given tooth contour. That also means that a low score has to be assigned to contour points that are not related to teeth.

This is similar to a classification problem that is to associate a score to each pixel of the image on input. A learning database can be constructed for this purpose by manual annotation. In this case, it is necessary to have images of teeth and manually annotate the contours of teeth in them. The work of Piotr Dollar, “Supervised Learning of Edges and Object Boundaries” can therefore be considered during this step.

The fitting sub-step (“approximation” in French) consists of adjusting automatically all the parameters of the 3D statistical shape model of teeth to make it correspond to the patient's teeth. As a reminder, the model includes both shape parameters and tooth position parameters. The sub-step addresses a problem of digital optimization that minimizes the distance between the contours detected in the images and the contours induced by the projection of the 3D model deformed in the images. As input to this sub-step, there is a defined number of images. This fitting takes into account at the same time the projection of the model of teeth in all the images, and finds the best combination of parameters to perform the fitting.

A statistical image processing algorithm can be used for automatically identifying a tooth from at least one 2D image, this algorithm being configured to recognize a predefined pattern and statistically associate a type of tooth with this pattern. The term ‘statistical’ comes from the fact that in the modeling of shapes from a large amount of data a statistical model is matched to a set of images. In this model, the teeth are not recognized as such, but rather parameters of the statistical model are modified to match them to the appearance of teeth in the photos. Such a model is constructed, for example, from a large number of 3D tooth scans. The advantage of such an approach is that it makes it possible to statistically model the deformations of the shapes of teeth and to parametrize them. This means that this model makes it possible to reproduce the shapes of any tooth whatsoever simply by adjusting the parameters of the 3D statistical shape model.

In some variants, at least one image used in this way presents depth information associated with each pixel captured. Each such image is captured, for example, by an RGB-D capture device.

In some variants, at least two 2D images are captured and an interpolation is carried out to associate a pixel representative of a single portion of the face with coordinates in a virtual geometric reference space, by triangulation for example.

The second modeling step 140 is performed, for example, by utilizing an electronic computing circuit, such as a computer or server, configured to compute a dentition shape in a virtual geometric reference space from detected teeth.

For example, during this modeling step 140, at least one tooth is positioned according to the geometric reference space, the tooth shape being extrapolated, or interpolated, from the coordinates of each said tooth.

To ensure the uniformity of the geometric reference space of the dentition and face shape models, one of the anatomical landmarks detected during the first detection step 115 can be one or more of the patient's teeth, with this tooth serving as a reference point during the second step 140 of modeling the patient's teeth for incorporating the dentition model and the face shape model in a single geometric reference space.

In some particular embodiments, such as that shown in FIG. 2, the method 200 comprises a step 210 of automatically learning how to recognize a tooth based on at least one captured image, the computation step 135 being based on the machine learning performed.

The learning step 210 is carried out, for example, by utilizing a machine learning algorithm based on a sample of captured images or of a set of points extracted from captured images representative of determined teeth.

As can be understood, the steps of reconstructing the face shape 105 and of reconstructing the dentition 125 can be performed in parallel or successively, as shown in FIG. 2.

After these steps of reconstructing the face shape 105 and of reconstructing the dentition 125 have been performed, an assembly step 142 takes place. During this assembly step 142, the two models reconstructed separately are assembled in the reference space.

This step can be based on the 3D adjustment of the dentition model onto the face model by taking as reference facial photos in which a portion of the dentition and all of the face are visible.

The second step 144 of capturing an image of the patients face shape is performed, for example, in a similar way to one of the realization variants of the first capture step 110.

The second fitting step 146 is performed, for example, in the same way as the first fitting step 120. During this second fitting step 146, the shape of a portion of the lower portion of the face to be fitted, for example, is fitted onto an upper portion fitted during the fitting step 120.

The positioning step 147 is similar to the assembly step 142 in that it consists of a 3D fitting of the fitted face model into a reference space containing the rigid portions of the face, such as the forehead and the nose, for example.

The step 145 of determining at least one dental treatment plan is performed, for example, by utilizing an electronic computing device configured to determine a possible treatment plan for at least one tooth. A possible treatment plan is determined based on the relative position of the tooth in relation to at least one other tooth of the dentition or in relation to the face.

A “treatment plan” is defined as all the changes to be carried out on the teeth (changes of shape, movement, rotation, etc.). This is expressed by all the changes in the parameters of the models of the patient's teeth.

Each treatment plan has an initial state, corresponding to the state of the model of the patient's dentition, and a final state, corresponding to a secondary model in which at least one tooth has undergone treatment, thereby changing the model of both the dentition and the face shape.

In addition, each treatment plan can include sequencing of the individual treatment plan of each tooth having an impact on the face shape and dentition depending on the succession of treatments carried out.

This determination step 145 consists of automatically generating orthodontic or prosthetic treatment plans while respecting the aesthetic indicators.

That is because this determination step 145 consists of adjusting the parameters of the 3D models of teeth obtained during the reconstruction step 125 under two constraints:
first of all, the movements of the teeth have to be realistic and possible in that the movement of one tooth is naturally limited and constrained by the rest of the patient's teeth; and
secondly, the treatment plan must improve or respect the patient's aesthetic criteria.

The optional selection step 150 consists of selecting, via a human-machine interface, a treatment plan from among at least one treatment plan determined during the determination step 145. This selection step 150 can consist, for example, in clicking on a button of a digital interface representative of a treatment plan, the click triggering the selection of said treatment plan.

In some embodiments, the selection step 150 is random or performed automatically.

The second capture step 144 is performed randomly in a similar way to the capture step 110, i.e. using a 2D, 3D or RGBD capture device capturing an image or a flow of images.

The step 155 of computing an image is performed, for example, in a similar way to the first fitting step 120 and based on the treatment plan selected and of the impact of this treatment plan on the parameters of the model of the patient's face shape. For example, the rotation a tooth can result in the movement of a lip or a cheek.

The fitting step 160 is performed, for example, on a digital screen. During this fitting step 160, an image that is fully computed and virtual can be displayed. In some variants, an image based on incorporating a virtual computed portion into a faithful image, such as a photograph for example, can be displayed.

In some embodiments, such as that shown in FIG. 2, the display step 160 is performed in augmented reality, the method comprising, before the display step, a step 295 of reducing a portion of the face of a user captured in a flow of images.

The reduction step 295 consists of removing from the flow of images a portion of the user's face corresponding to a portion to be replaced by a modeled portion. This reduction step 295 is performed, for example, by utilizing an electronic computing circuit executing an image processing computer program configured to detect a portion of the face to be removed and remove it from the flow of images captured.

The computation step consists of computing an image of the patient's face, from the captured image flow and the patient's face computed after the treatment plan has been performed. This reduction step 295 is performed, for example, by utilizing an electronic computing circuit executing a computation and image processing computer program.

During this reduction step 295, the actual dentition of the patient is removed from the image while preserving the realistic textures of the patient's mouth. Schematically, the following sub-steps can be performed:
removing teeth by image processing;
locating and segmenting teeth by applying a result obtained by the learning step 210; and
filling the removed space by a texture determined in relation to the image of the captured dentition or a predefined texture.

In some particular embodiments, such as that shown in FIG. 2, the method 200 comprises a step 225 of providing, based on the treatment plan chosen, a schedule of tasks to be carried out.

The provision step 225 is performed, for example, by utilizing a screen displaying the schedule of tasks of the treatment plan. A schedule of tasks associates a date to a step of the treatment plan selected or determined.

In some variants not shown, the method 200 comprises a step of the 3D printing of a splint based on the dentition modeled during the reconstruction step 125.

Over ten years ago, a new treatment technique for teeth alignment (orthodontic treatment) appeared. This technique no longer concerns gluing mechanical retention elements onto the teeth in order to place a wire containing movement information there. This technique is based on using a series of thermoformed splints to exert pressure on the teeth with the aim of moving them.

Currently, the series of splints (between 7 and 28 splints, depending on treatments) are produced by thermoforming. That means that a series of models are produced so as to establish intermediate tooth positions, and that plates made of plastic (about 0.7 mm thick) are applied to these models, before heating them under vacuum, so that they take the shape of the model.

Currently, the step of producing intermediate models is essential. It is performed, to a great extent, by 3D printing.

In this variant, the splints are directly printed in 3D with no intermediate model. This would produce a considerable saving in time and materials. However the splints, which are not transparent, are brittle, rigid and their mechanical properties degrade rapidly due to the oral temperature and saliva.

To avoid such a problem, the variant mentioned utilizes 3D printing in a biocompatible material suitable for going in the mouth, able to withstand the intra-oral medium, preferably having a pleasing appearance, and resilient at a minimal thickness.

To produce such a material, a mixture of polymers is produced for the printing and then it is all sprayed or immersed in a solvent to be able to degrade one of the polymers, thus making it possible to adjust the mechanical properties.

Because of this, the technique should enable the splints to be printed without need for finishing (apart from smoothing the edges).

1. A method for estimating and viewing a result of a dental treatment plan, comprising:
a step of positioning retractors in a patient's mouth;
a step of reconstructing a patient's face shape in a first 3D virtual space; comprising:
a first step of capturing, by an RGB-D capture device, at least one image of the patient's face; and
a first step of fitting the shape of at least one portion of the patient's face onto a parametric face shape model based on at least one captured image of the face;
a step of reconstructing the dentition of a patient in a second 3D virtual space, comprising:
a step of capturing, by a capture device, an image of the dentition of the patient;
a step of computing a probabilistic contour map of at least one tooth of the dentition based on at least one captured image; and
a step of modeling the 3D shape of at least one tooth based on a probable position of at least one contour;
a step of assembling the reconstructed face shape and the reconstructed dentition in a common 3D virtual space;
a step of removing retractors from the patient's mouth;
a second step of capturing an image of the patient's face shape;
a second step of fitting the patient's face shape onto a parametric face shape model based on at least one image of the face captured during the second capture step, in a 3D space;
a step of positioning the modeled dentition in the 3D virtual space of the face shape fitted during the second fitting step;
a step of determining at least one dental treatment plan based on both the modeled dentition and face shape;
a step of selecting a treatment plan from the set of determined treatment plans;
a step of computing an image of how the patient's face will look after the dental treatment based on an image of the patient's face and on the selected treatment plan; and
a step of displaying the computed image.

2. The method according to claim 1, which comprises a step of automatically learning how to recognize an anatomical landmark based on at least one captured image, the detection step being based on the machine learning performed.

3. The method according to claim 1, which comprises a step of automatically learning how to recognize a tooth based on at least one captured image, the detection step being based on the machine learning performed.

4. The method according to claim 3, wherein the step of automatically learning how to recognize a tooth is configured to learn a statistical distribution of tooth shapes from captured 3D tooth scans to produce a parametric tooth shape model.

5. The method according to claim 1, wherein the display step is performed in augmented reality, the method comprising, before the display step, a step of reducing a portion of the face of a user captured in a flow of images.

6. The method according to claim 5, wherein the reduction step comprises:
a step of removing teeth by image processing;
a step of locating and segmenting teeth by applying a result obtained by automatically learning how to recognize a tooth; and
a step of filling the removed space by a texture.

7. The method according to claim 1, wherein the image captured during the step of capturing at least one image of at least one tooth of the patient is an image of an impression of the patient's teeth.

8. The method according to claim 1, which comprises a step of providing, based on the treatment plan chosen, a schedule of tasks to be carried out.

9. The method according to claim 1, wherein the second detection step is performed based on the parametric fitting of the shape of a captured tooth relative to a distribution of tooth shapes obtained beforehand.

10. The method according to claim 9, wherein the second capture step captures at least one 2D image of a tooth at one camera angle, the second detection step performing the parametric fitting of the shape of a tooth based on a projection corresponding to the camera angle.

11. The method according to claim 1, which comprises a plurality of capture steps, to produce a plurality of images taken from different angles of view.

12. The method according to claim 1, wherein at least one capture step is performed with a 2D image capture device.

13. The method according to claim 1, wherein the step of computing a probabilistic contour map is performed based on images captured in two dimensions during the capture step, the computed map being computed based on a projection of the teeth in a captured image.
